(19) United States
(12) Patent Application Publication
(10) Pub. No.: US 2025/0232775 A1
(43) Pub. Date: Jul. 17, 2025

(54) SPEAKER VERIFICATION DEVICE, METHOD OF CONTROLLING SPEAKER VERIFICATION DEVICE, AND SPEAKER VERIFICATION SYSTEM

(71) Applicant: IUCF-HYU(INDUSTRY-UNIVERSITY COOPERATION FOUNDATION HANYANG UNIVERSITY), Seoul (KR)

(72) Inventors: Joon Hyuk CHANG, Seoul (KR); Jeong Hwan CHOI, Seoul (KR); Ye Rin JEOUNG, Seoul (KR)

(21) Appl. No.: 19/012,768

(22) Filed: Jan. 7, 2025

(30) Foreign Application Priority Data
Jan. 17, 2024 (KR) 10-2024-0007538

(51) Int. Cl. G10L 17/04; G10L 17/18

(52) U.S. Cl. CPC G10L 17/04; G10L 17/18

(57) ABSTRACT

According to one embodiment of the present disclosure, the speaker verification device comprises a memory configured to store a neural network model including a student network and a teacher network; and at least one processor configured to train the neural network model, wherein the at least one processor is configured to determine a first loss function based on a difference between outputs of the student network and the teacher network for unlabeled utterances; determine a second loss function based on a difference between an output of the student network for labeled utterances and a one-hot encoding result for the labeled utterances; update parameters of the student network based on the first and second loss functions; and update parameters of the teacher network based on an exponential moving average of the updated parameters of the student network.

### CROSS REFERENCE TO RELATED APPLICATION

This application claims priority under 35 U.S.C § 119 to Korean Patent Application No. 10-2024-0007538 filed on Jan. 17, 2024, in the Korean Intellectual Property Office, the entire contents of which are hereby incorporated by reference.

### BACKGROUND

### Technical Field

The present invention relates to a speaker verification device capable of verifying a speaker through utterances.

### Description of the Related Art

Speaker verification devices use a fixed-size vector called a speaker embedding to determine whether a pair of utterances originates from the same speaker.

Speaker embeddings are typically extracted by a neural network model that learns methods to distinguish speakers from numerous utterances obtained from various speakers.

Recording large volumes of utterances requires substantial time and cost. Labeling each utterance with speaker identifiers is impractical due to privacy concerns associated with collecting speaker identity information.

Consequently, recent studies have employed self-supervised learning frameworks to utilize large-scale unsupervised datasets in speaker verification devices.

### SUMMARY

A speaker verification device is provided that provides semi-supervised learning by sharing an encoder and a projection layer between supervised and self-supervised learning, allowing training with both labeled and unlabeled utterances.

According to one embodiment of the present disclosure, the speaker verification device comprises a memory configured to store a neural network model including a student network and a teacher network; and at least one processor configured to train the neural network model, wherein the at least one processor is configured to determine a first loss function based on a difference between outputs of the student network and the teacher network for unlabeled utterances; determine a second loss function based on a difference between an output of the student network for labeled utterances and a one-hot encoding result for the labeled utterances; update parameters of the student network based on the first and second loss functions; and update parameters of the teacher network based on an exponential moving average of the updated parameters of the student network.

Each of the student network and the teacher network includes: an encoder configured to convert segments of utterances into speaker embeddings; and a projection head configured to map the speaker embeddings into a high-dimensional space, and the projection head includes: a multilayer perceptron; and a projection layer configured to receive a representation output from the multilayer perceptron and map the representation into a high-dimensional space.

The at least one processor is configured to: determine an auxiliary contrastive loss function based on a cosine similarity between the representation output from the multilayer perceptron of the student network and the speaker embedding output from the encoder of the teacher network; and update the parameters of the student network based on the auxiliary contrastive loss function.

The at least one processor is configured to determine a positive component of the auxiliary contrastive loss function such that the cosine similarity between the representation of the student network and the speaker embedding of the teacher network, both derived from the same utterance, approaches 1.

The at least one processor is configured to determine a negative component of the auxiliary contrastive loss function such that the cosine similarity between the representation of the student network output based on labeled utterances and the speaker embedding of the teacher network output based on unlabeled utterances becomes less than 0.

The at least one processor is configured to sequentially perform pre-training without a margin penalty and fine-tuning training with a margin penalty when updating the parameters of the student network and the teacher network.

The at least one processor is configured to control a temperature of a softmax function, which controls sharpness of network outputs to be higher in the student network than in the teacher network during the pre-training.

The at least one processor is configured to control the temperature to be the same for both the student network and the teacher network during the fine-tuning training.

A method for controlling a speaker verification device comprising a memory configured to store a neural network model including a student network and a teacher network, and at least one processor configured to train the neural network model, the method comprises determining a first loss function based on a difference between outputs of the student network and the teacher network for unlabeled utterances; determining a second loss function based on a difference between an output of the student network for labeled utterances and a one-hot encoding result for the labeled utterances; updating parameters of the student network based on the first and second loss functions; and updating parameters of the teacher network based on an exponential moving average of the updated parameters of the student network.

Each of the student network and the teacher network includes an encoder configured to convert segments of utterances into speaker embeddings; and a projection head configured to map the speaker embeddings into a high-dimensional space, the projection head includes a multilayer perceptron; and a projection layer configured to receive a representation output from the multilayer perceptron and map the representation into a high-dimensional space, the method further comprises determining an auxiliary contrastive loss function based on a cosine similarity between the representation output from the multilayer perceptron of the student network and the speaker embedding output from the encoder of the teacher network; and updating the parameters of the student network based on the auxiliary contrastive loss function.

The determining of the auxiliary contrastive loss function includes determining a positive component of the auxiliary contrastive loss function such that the cosine similarity between the representation of the student network and the speaker embedding of the teacher network, both derived from the same utterance, approaches 1.

The determining of the auxiliary contrastive loss function includes determining a negative component of the auxiliary contrastive loss function such that the cosine similarity between the representation of the student network output based on labeled utterances and the speaker embedding of the teacher network output based on unlabeled utterances becomes less than 0.

The method for controlling the speaker verification device comprises sequentially performing pre-training without a margin penalty and fine-tuning training with a margin penalty when updating the parameters of the student network and the teacher network.

The sequentially performing of the pre-training and the fine-tuning training includes controlling a temperature of a softmax function, which controls sharpness of network outputs to be higher in the student network than in the teacher network during the pre-training.

The sequentially performing of the pre-training and the fine-tuning training includes controlling the temperature to be the same for both the student network and the teacher network during the fine-tuning training.

A speaker verification system comprises a user terminal; and
a speaker verification device which receives utterances and a speaker verification request from the user terminal, inputs the received utterances into a neural network model, performs speaker verification based on an output of the neural network model, and sends a speaker verification result to the user terminal, the speaker verification device including: a memory configured to store the neural network model; and at least one processor configured to train the neural network model, wherein the at least one processor is configured to: determine a first loss function based on a difference between outputs of the student network and the teacher network of the neural network model for unlabeled utterances; determine a second loss function based on a difference between an output of the student network for labeled utterances and a one-hot encoding result for the labeled utterances; update parameters of the student network based on the first and second loss functions; and update parameters of the teacher network based on an exponential moving average of the updated parameters of the student network.

According to one embodiment, the speaker verification device provides semi-supervised learning by sharing the encoder and the projection layer in supervised and self-supervised learning, allowing training with both labeled and unlabeled utterances.

### BRIEF DESCRIPTION OF DRAWINGS

FIG. 1 illustrates a speaker verification system according to one embodiment.

FIG. 2 is a control block diagram of a speaker verification device according to one embodiment.

FIG. 3 illustrates the neural network training framework of a speaker verification device according to one embodiment.

FIG. 4 illustrates a case where a speaker verification device determines an auxiliary contrastive loss function according to one embodiment.

FIG. 5 illustrates the steps for performing training in a speaker verification device according to one embodiment.

FIG. 6 is a flowchart illustrating the process of training a neural network model in the control method of a speaker verification device according to one embodiment.

FIG. 7 is a flowchart illustrating the process of training a neural network model while considering an auxiliary contrastive loss function in the control method of a speaker verification device according to one embodiment.

FIG. 8 is a flowchart illustrating the process of training a neural network model in two stages in the control method of a speaker verification device according to one embodiment.

### DETAILED DESCRIPTION

The same reference numerals throughout the specification refer to the same components. This specification does not describe all elements of the embodiments, and common or repetitive content between the embodiments or in the relevant technical field is omitted.

It will be understood that when an element is referred to as being “connected” another element, it can be directly or indirectly connected to the other element, wherein the indirect connection includes “connection via a wireless communication network”.

Also, when a part “includes” or “comprises” an element, unless there is a particular description contrary thereto, the part may further include other elements, not excluding the other elements.

Throughout the description, when a member is “on” another member, this includes not only when the member is in contact with the other member, but also when there is another member between the two members.

Additionally, terms like ‘˜unit’, ‘˜device’, ‘˜block’, ‘˜component’, and ‘˜module’ can refer to a unit that handles at least one function or operation. For example, the aforementioned terms may refer to at least one hardware component, such as an FPGA (field-programmable gate array) or an ASIC (application-specific integrated circuit), or at least one software stored in memory, or at least one process handled by a processor.

An identification code is used for the convenience of the description but is not intended to illustrate the order of each step. The each step may be implemented in the order different from the illustrated order unless the context clearly indicates otherwise.

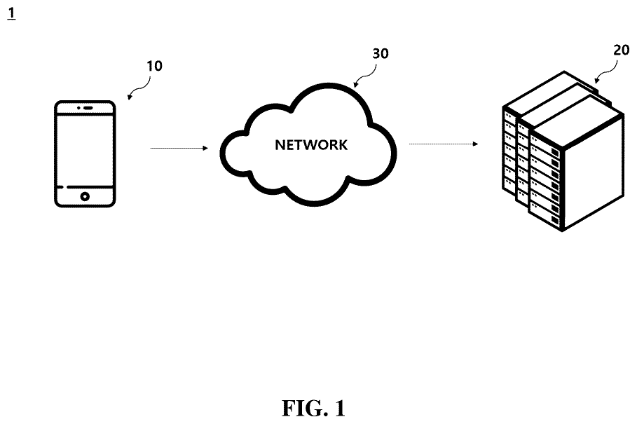

FIG. 1 illustrates a speaker verification system according to one embodiment.

Referring to FIG. 1, a speaker verification system 1 according to one embodiment includes a user terminal 10 for receiving user utterances, a speaker verification device 20 for verifying the speaker based on the user utterances, and a network 30 for supporting communication between the user terminal 10 and the speaker verification device 20.

The user terminal 10 according to one embodiment can receive user utterances via a microphone (not shown) and request verification of the speaker for the utterances to the speaker verification device 20 via the network 30. For example, the user terminal 10 can be an electronic device such as a smartphone.

The speaker verification device 20 according to one embodiment can verify the speaker of user utterances using a neural network model and train the neural network model to improve the accuracy of speaker verification.

For example, the speaker verification device 20, upon receiving user utterances and a speaker verification request from the user terminal 10, can verify the speaker using the neural network model and send the verification results back to the user terminal 10.

In particular, the speaker verification device 20 according to one embodiment can perform supervised learning on the neural network model based on labeled utterances and self-supervised learning on the neural network model based on unlabeled utterances simultaneously.

That is, the speaker verification device 20 can provide semi-supervised learning by sharing the encoder and projection layer in both supervised and self-supervised learning, allowing training with both labeled and unlabeled utterances.

Specifically, when performing self-supervised learning, the speaker verification device 20 employs a DINO (self-distillation with no labels) learning framework, which distills knowledge from a teacher network to a student network on the neural network model.

In other words, the speaker verification device 20 provides a joint learning framework that uses both the DINO and supervised learning frameworks.

An embodiment in which the speaker verification device 20 trains the neural network model will be described in detail later.

The network 30 according to one embodiment supports at least one of wired or wireless communication between the user terminal 10 and the speaker verification device 20. The network 30 can include telecommunication networks, such as computer networks (e.g., LAN or WAN), the Internet, or telephone networks.

The configuration of the speaker verification system 1 has been described above. The following section provides a detailed description of the configuration of the speaker verification device 20 and the training operation of the neural network model.

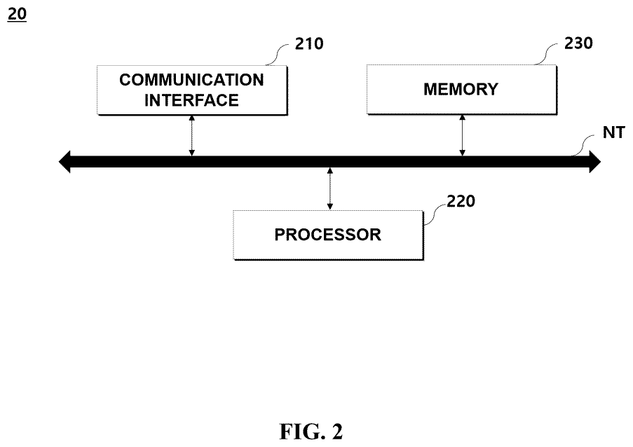

FIG. 2 is a control block diagram of the speaker verification device 20 according to one embodiment.

Referring to FIG. 2, the speaker verification device 20 according to one embodiment includes a communication interface 210 for communicating with external devices, at least one processor 220 for training the neural network model, and a memory 230 for storing the neural network model.

The communication interface 210 according to one embodiment can perform communication with external devices to send and receive data. For example, the communication interface 210 can communicate with the user terminal 10 via the network 30.

To this end, the communication interface 210 may include a wired communication module or a wireless communication module of a known type.

At least one processor 220 according to one embodiment can perform self-supervised learning on the neural network model based on unlabeled utterances and supervised learning on the neural network model based on labeled utterances.

At this time, the neural network model may include a student network and a teacher network. The network of the neural network model may include an encoder for converting segments of utterances into speaker embeddings and a projection head for mapping the speaker embeddings into a high-dimensional space. The projection head may include a multilayer perceptron and a projection layer that receives the representations output by the multilayer perceptron and maps them into a high-dimensional space.

The processor 220 can perform self-supervised learning based on the difference between the outputs of the student network and teacher network for unlabeled utterances.

Furthermore, the processor 220 can configure the student network to share the encoder and projection head of the student network between self-supervised and supervised learning by utilizing the student network in supervised learning.

Specifically, the processor 220 can perform supervised learning based on the difference between the output of the student network for labeled utterances and the one-hot encoding results for the labeled utterances.

At least one processor 220 in one embodiment can determine an auxiliary contrastive loss function based on the cosine similarity between the representations output by the multilayer perceptron of the student network and the speaker embeddings output by the encoder of the teacher network and then update the student network parameters based on the auxiliary contrastive loss function.

When training the neural network model, at least one processor 220 in one embodiment can sequentially perform pre-training without margin penalties and fine-tuning training with margin penalties.

For instance, the processor 220 may be a central processing unit (CPU) or a graphics processing unit (GPU) and may include volatile memory for training the neural network model.

An embodiment in which at least one processor 220 trains the neural network model will be described in further detail later.

Additionally, at least one processor 220, upon receiving utterances and a speaker verification request from the user terminal 10, can input the received utterances into the trained neural network model, perform speaker verification based on the output of the neural network model, and control the communication interface 210 to transmit the speaker verification results to the user terminal 10.

The memory 230 in one embodiment can store the neural network model and utterance data necessary for training the neural network model. For this purpose, the memory 230 may be configured as a known type of non-volatile memory.

The above-described components can communicate with each other through the communication network (NT).

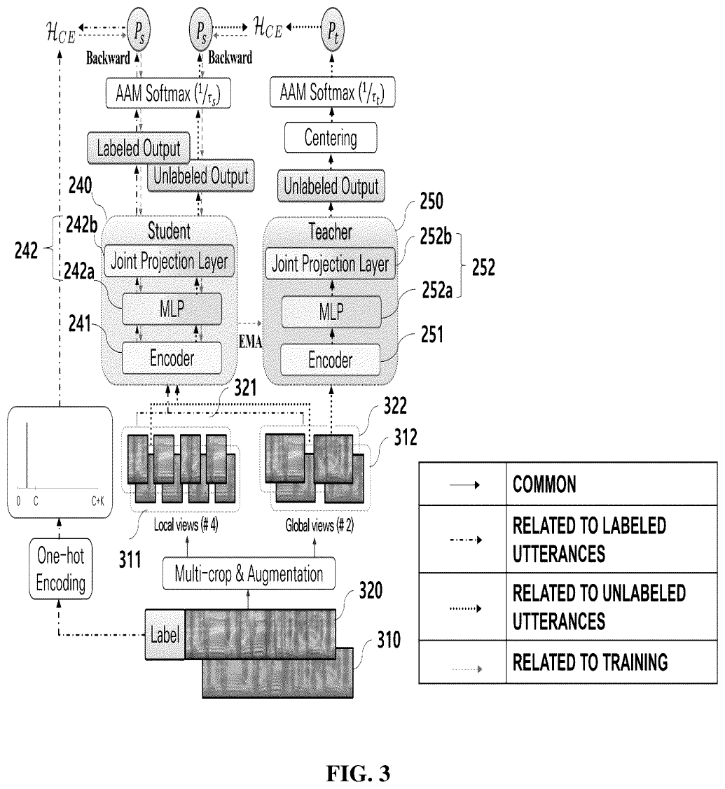

FIG. 3 illustrates the neural network training framework of the speaker verification device 20 according to one embodiment.

Referring to FIG. 3, the speaker verification device 20 in one embodiment can perform self-supervised learning on the neural network model based on unlabeled utterances 310 and supervised learning on the neural network model based on labeled utterances 320.

The neural network model may include a student network 240 and a teacher network 250. Both networks 240 and 250 of the neural network model may include encoders 241 and 251 for converting utterance segments into speaker embeddings and projection heads 242 and 252 for mapping the speaker embeddings into a high-dimensional space. The projection heads 242 and 252 may include multilayer perceptrons 242a and 252a and projection layers 242b and 252b that receive the representations output by the multilayer perceptrons 242a and 252a and map them into a high-dimensional space.

The speaker verification device 20 can perform self-supervised learning based on the difference in outputs Pₛ and Pₜ of the student network 240 and the teacher network 250 for unlabeled utterances 310.

In other words, the speaker verification device 20 can determine a first loss function based on the difference in outputs Pₛ and Pₜ of the student network 240 and the teacher network 250 for unlabeled utterances 310.

Specifically, the speaker verification device 20 can sample the unlabeled utterances 310 using a multi-crop augmentation method and crop the utterances 310 indexed as i for speaker differentiation into four local views vₗⁱ 311 and two global views v_{g}ⁱ 312. The local views 311 may be segments of length Nₗ, while the global views 312 may be segments of length N_{g}, where N_{g}>Nₗ. However, the number of local views 311 and global views 312 is merely exemplary. According to the embodiment, the number of local views 311 just needs to exceed the number of global views 312, with no specific limit on the exact count of each view.

The speaker verification device 20 inputs both the local views 311 and global views 312 into the student network 240, while only the global views 312 are input into the teacher network 250.

The views provided to the networks 240 and 250 are sequentially processed by the encoders 241 and 251 and projection heads 242 and 252. The latent representation xᵢ just before the final layer, specifically the output of the multilayer perceptrons 242a and 252a, has the same size as the speaker embeddings. This representation is normalized before being input into the final projection layer 242b, 252b, which is a K-dimensional layer. Similarly, the weight matrix W is normalized.

Additionally, the speaker verification device 20 can use a softmax function to control the sharpness of the outputs from the networks 240 and 250.

The k-th component Pₛ(vᵢ)ₖ of the output probability Pₛ(vᵢ) of the student network 240 is represented as Math. 1.

$${{P}_{s} ( {υ}^{i} )}_{k} = \frac{{e}^{cos ( {θ}_{k} ) / {τ}_{s}}}{{\sum }_{j = 1}^{K} {e}^{cos ( {θ}_{j} ) / {τ}_{s}}} . \qquad [ Math . 1 ]$$

In Math. 1, τₛ represents the temperature used in the student network 240, and θⱼ denotes the angle between xᵢ and the j-th column of the weight matrix W in the final layer 242b of the student network 240.

The formula for Pₜ of the teacher network 250 is also applied as in Math. 1, and the first loss function (LDINOi) is minimized using the cross entropy between Pₜ and Pₛ, as shown in Math. 2.

$${ℒ}_{DINO}^{i} = {\sum }_{{υ}^{i} ∈ {V}_{g}^{i}} {\sum }_{{{\tilde{υ}}^{i} ∈ {V}_{all}^{i}}_{{υ}^{i} \neq {\tilde{υ}}^{i}}} {ℋ}_{CE} ( {P}_{t} ( {υ}^{i} ) , {P}_{s} ( {\tilde{υ}}^{i} ) ) \qquad [ Math . 2 ]$$

In Math. 2, V_{g} refers to the set that includes the global view 312, and Vₐₗₗ refers to the set that includes all views 311 and 312. Additionally, H_{CE}(a,b) denotes the expression −a−log b.

The speaker verification device 20 can update the parameters of the student network 240 based on the first loss function and update the parameters of the teacher network 250 based on the exponential moving average (EMA) of the updated parameters of the student network 240. Here, parameters refer to the weights and biases corresponding to the configuration of the neural network model. The neural network model continuously updates its parameters through training, thereby improving the reliability of the training.

If Pₜ exhibits a dominant distribution along one dimension for all utterances, it may lead to collapse. To prevent this issue, the processor 220 can apply centering by subtracting the mean of latent vectors x from all batches in the teacher network 250.

Moreover, the speaker verification device 20 can share the encoder 231 and projection head 232 of the student network 240 in self-supervised and supervised learning by utilizing the student network 240 for supervised learning. In other words, the projection layer 242b, which is the final layer of both supervised and semi-supervised learning, is combined into a single layer and utilized as a joint projection layer with a weight matrix of size R_{D×(K+C)}. Here, D is the embedding size, K is the size of the projection layer 242b, and C is the number of speakers.

In other words, the speaker verification device 20 can perform supervised learning based on the difference between the output of the student network for labeled utterances 320 and the one-hot encoding results for the labeled utterances 320.

In other words, the speaker verification device 20 can determine a second loss function based on the difference between the output of the student network for labeled utterances 320 and the one-hot encoding results for the labeled utterances 320 and update the parameters of the student network 240 based on the second loss function.

Specifically, the speaker verification device 20 can sample the labeled utterances 320 using a multi-crop augmentation method and crop them into four local views 321 and two global views 322. The number of local views 321 and global views 322 is merely exemplary. According to the embodiment, the number of local views 321 just needs to exceed the number of global views 322, with no specific limit on the exact count of each view.

At this time, the local views 321 and global views 322 of the labeled utterances 320 are input into the student network 240, and the views input to the student network 240 are sequentially supplied to the encoder 241 and projection head 242.

The k-th component Pₛ(vᵢ)ₖ of the output probability Pₛ(vᵢ) of the student network 240 for each view of the labeled utterances 320 is represented as Math. 3.

$${{P}_{s} ( {υ}^{i} )}_{k} = \{ \begin{matrix}\frac{{e}^{cos ( {θ}_{k} + m ) / {τ}_{s}}}{{e}^{cos ( {θ}_{k} + m ) / {τ}_{s}} + {\sum }_{{j = 1}_{j \neq \overline{k}}}^{K + C} {e}^{cos ( {θ}_{j} ) / {τ}_{s}}} & if k = k \\ \frac{{e}^{cos ( {θ}_{k} ) / {τ}_{s}}}{{e}^{cos ( {θ}_{k} + m ) / {τ}_{s}} + {\sum }_{{j = 1}_{j \neq \overline{k}}}^{K + C} {e}^{cos ( {θ}_{j} ) / {τ}_{s}}} & otherwise\end{matrix} \qquad [ Math . 3 ]$$

In Math. 3, k-represents the index for which the target is maximized, and m denotes the margin penalty.

In this way, the speaker verification device 20 can perform supervised learning by updating the parameters of the student network 240 based on the first loss function based on self-supervised learning and the second loss function based on supervised learning and updating the parameters of the teacher network 250 using the exponential moving average of the updated parameters of the student network 240.

The speaker verification device 20 uses the output Pₜ of the teacher network 250 for unlabeled utterances 320 as the target for the output Pₛ of the student network 240 for the labeled utterances 320 so that Ps can be trained toward Pₜ.

The speaker verification device 20 uses the one-hot encoding result yⁱ for labeled utterances 320 as the target of the output Ps of the student network 240 for the labeled utterances 320 so that Ps can be trained toward yⁱ.

As a result, the speaker verification device 20 can train the neural network model based on the loss function L_{JL}ⁱ as described in Math. 4.

$${ℒ}_{JL}^{i} = {\sum }_{{υ}^{i} ∈ {V}_{g}^{i}} {\sum }_{{{\tilde{υ}}^{i} ∈ {V}_{all}^{i}}_{{υ}^{i} \neq {\tilde{υ}}^{i}}} \{ \begin{matrix}{ℋ}_{CE} ( {P}_{t} ( {υ}^{i} ) , {P}_{s} ( {\tilde{υ}}^{i} ) ) & if {y}^{i} does not exist \\ {ℋ}_{CE} ( {Y}_{i} , {P}_{s} ( {υ}^{i} ) ) & if {y}^{i} exists\end{matrix} \qquad [ Math . 4 ]$$

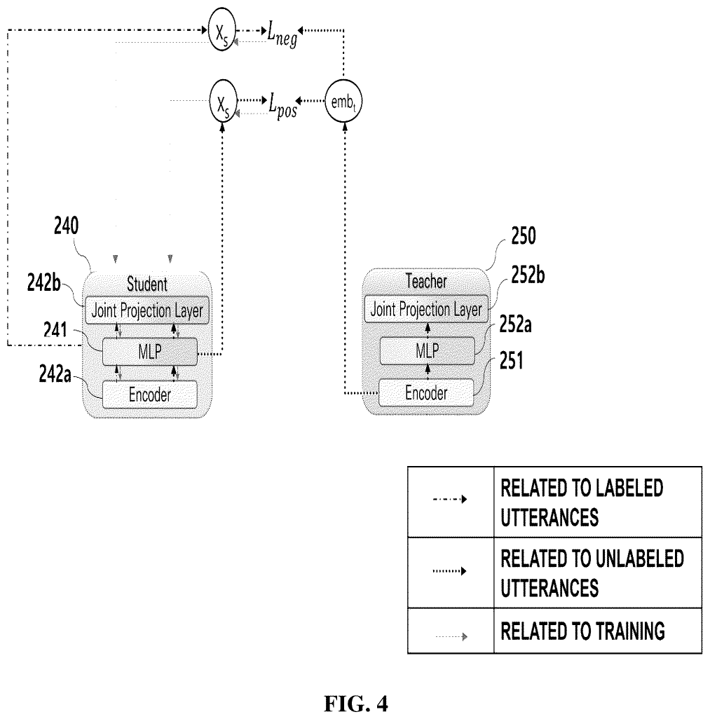

FIG. 4 illustrates an example where the speaker verification device 20 determines an auxiliary contrastive loss function.

Referring to FIG. 4, in an embodiment, the speaker verification device 20 can determine an auxiliary contrastive loss function based on the cosine similarity between the representation Xₛ output from the multilayer perceptron 242a of the student network 240 and the speaker embedding embₜ output from the encoder 251 of the teacher network 250, and update the parameters of the student network 240 based on the auxiliary contrastive loss function.

Specifically, the speaker verification device 20 can determine the positive component (Lₚₒₛⁱ) of the auxiliary contrastive loss function such that the cosine similarity between the representation Xₛ of the student network 240 and the speaker embedding embₜ of the teacher network 250, derived based on the same utterance, approaches 1.

The positive component (Lₚₒₛⁱ) of the auxiliary contrastive loss function can be represented as Math. 5, where A (a, b) denotes the angle between vectors a and b, and Eₜ and Mₛ represent the encoder 251 of the teacher network 250 and the multilayer perceptron 242a of the student network 240, respectively.

$${ℒ}_{pos}^{i} = {\sum }_{{υ}^{i} ∈ {V}_{g}^{i}} {\sum }_{{\tilde{υ}}^{i} ∈ {V}_{all}^{i}} ( 1 - cos ( 𝒜 ( {E}_{t} ( {υ}^{i} ) , {M}_{s} ( {\tilde{υ}}^{i} ) ) ) ) \qquad [ Math . 5 ]$$

Additionally, the speaker verification device 20 can determine the negative component (Lnegi,j) of the auxiliary contrastive loss function such that the cosine similarity between the representation Xₛ of the student network 240 output based on labeled utterances and the speaker embedding embₜ of the teacher network 250 output based on unlabeled utterances becomes less than 0.

The negative component (L_{neg}^{i,j}) of the auxiliary contrastive loss function can be represented as Math. 6.

$${ℒ}_{neg}^{i , j} = {\sum }_{{υ}^{i} ∈ {V}_{g}^{i}} {\sum }_{{\tilde{υ}}^{j} ∈ {V}_{all}^{j}} max ( 0 , cos ( 𝒜 ( {E}_{t} ( {υ}^{i} ) , {M}_{s} ( {υ}^{j} ) ) ) ) \qquad [ Math . 6 ]$$

In one embodiment, the speaker verification device 20 can update the parameters of the student network 240 using the total loss function (Lⱼₗₜₒₜₐₗ) as shown in Math. 7 by simultaneously considering the loss function (L_{JL}ⁱ) as defined in Math. 4, which includes the first loss function based on self-supervised learning and the second loss function based on supervised learning as well as the auxiliary loss functions (Lₚₒₛⁱ, L_{neg}^{i,j}).

$${ℒ}_{{JL}_{total}} = {{\sum }_{i}}^{{B}^{u} + {B}^{l}} ( {ℒ}_{JL}^{i} + {ℒ}_{pos}^{i} ) + {{\sum }_{u}}^{{B}^{u}} {{\sum }_{l}}^{{B}^{l}} ( {ℒ}_{neg}^{l , u} + {ℒ}_{neg}^{u , l} ) \qquad [ Math . 7 ]$$

In Math. 7, B represents the batch size, B^{u} indicates the size of the dataset of unlabeled utterances, and B¹ represents the size of the dataset of labeled utterances.

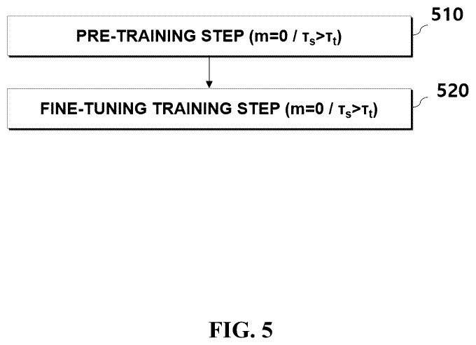

FIG. 5 illustrates the steps for performing training in the speaker verification device 20 in one embodiment.

Referring to FIG. 5, in one embodiment, the speaker verification device 20 can perform pre-training without a margin penalty (m=0) and fine-tuning training with a margin penalty (m>0) sequentially when performing training on the neural network model.

In other words, as shown in FIG. 5, the speaker verification device 20 can perform fine-tuning training step 520 after completing the pre-training step 510.

In this case, the speaker verification device 20 can control the temperature of the softmax function, which controls the sharpness of the network output, to be larger in the student network 240 than in the teacher network 250 (τₛ>τₜ) during pre-training.

Additionally, the speaker verification device 20 can control the temperature to be the same in both the teacher network 250 and the student network 240 (τₛ=τₜ) during fine-tuning training.

In this way, the speaker verification device 20 can prevent class collapse, which may occur when the weights of the teacher network 250 are fully dependent on the weights of the student network 240, by performing the pre-training step without a margin penalty.

Hereafter, the control method of the speaker verification device 20 according to an embodiment will be described. The control method of the speaker verification device 20 described below can be applied to the speaker verification device 20 according to the above-described embodiment. Therefore, the content explained with reference to FIG. 1 to FIG. 5 can be equally applied to the control method of the speaker verification device 20 according to an embodiment, even without special mention.

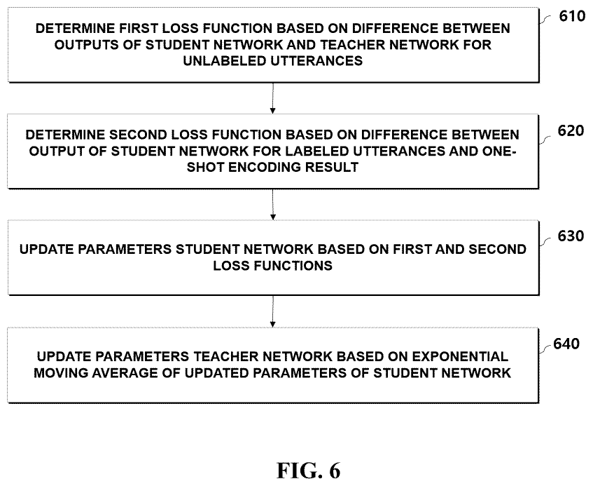

FIG. 6 illustrates a flowchart illustrating the process of training a neural network model in the control method of the speaker verification device 20 according to one embodiment.

Referring to FIG. 6, the speaker verification device 20 according to an embodiment can determine a first loss function (610) based on the output difference between the student network 240 and the teacher network 250 for the unlabeled utterance 310.

Additionally, the speaker verification device 20 can determine a second loss function 620 based on the difference between the output of the student network 240 for the labeled utterance 320 and the one-hot encoding result.

The speaker verification device 20 can update the parameters of the student network 240 based on the first and second loss functions (630), and update the parameters of the teacher network 250 using the exponential moving average of the updated parameters of the student network 240 (640).

By utilizing supervised learning for the student network 240, the speaker verification device 20 enables the encoder 231 and projection head 232 of the student network 240 to be shared across both self-supervised and supervised learning.

Thus, the speaker verification device 20 can perform semi-supervised learning by updating the parameters of the student network 240 based on the first and second loss functions and the parameters of the teacher network 250 based on the exponential moving average of the parameters of the student network 240.

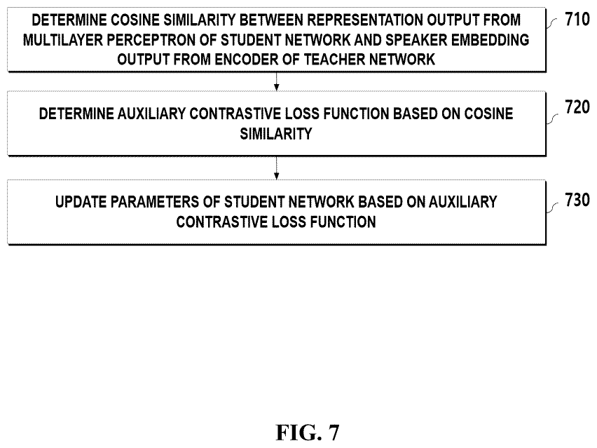

FIG. 7 illustrates a flowchart of the process of training a neural network model by further considering the auxiliary contrastive loss function in the control method of the speaker verification device 20 in one embodiment.

Referring to FIG. 7, in one embodiment, the speaker verification device 20 can determine the cosine similarity between the representation output from the multilayer perceptron 242a of the student network 240 and the speaker embedding output from the encoder 251 of the teacher network 250 (710), determine the auxiliary contrastive loss function based on the cosine similarity (720), and update the parameters of the student network 240 based on the auxiliary contrastive loss function 730.

Specifically, the speaker verification device 20 can determine the positive component (Lₚₒₛⁱ) of the auxiliary contrastive loss function such that the cosine similarity between the representation Xₛ of the student network 240 and the speaker embedding embₜ of the teacher network 250, derived based on the same utterance, approaches 1.

Additionally, the speaker verification device 20 can determine the negative component (L_{neg}^{i,j}) of the auxiliary contrastive loss function such that the cosine similarity between the representation Xₛ of the student network 240 output based on the labeled utterance and the speaker embedding embₜ of the teacher network 250 output based on the unlabeled utterance becomes less than 0.

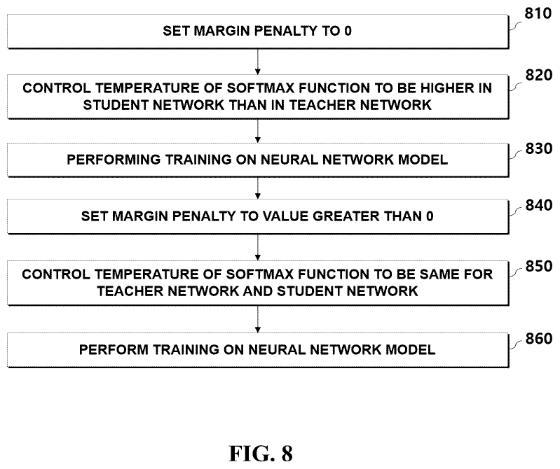

FIG. 8 illustrates a flowchart illustrating the process of training the neural network model in two stages in the control method of the speaker verification device 20 in one embodiment.

Referring to FIG. 8, in one embodiment, the speaker verification device 20 can set the margin penalty to 0 (810) and control the temperature of the softmax function to be higher in the student network 240 than in the teacher network 250 (820), thereby performing training of the neural network model (830).

Subsequently, the speaker verification device 20 can set the margin penalty to a value greater than 0 (840), control the temperature of the softmax function to be equal in both the teacher network 250 and the student network 240 (850), thereby performing training of the neural network model (860).

Thus, when training the neural network model, the speaker verification device 20 can sequentially perform pre-training without a margin penalty (m=0) and fine-tuning training with a margin penalty (m>0).

By performing the pre-training step without a margin penalty, the speaker verification device 20 can prevent class collapse, which occurs when the weights of the teacher network 250 are entirely dependent on the weights of the student network 240.

Meanwhile, the disclosed embodiments may be implemented in the form of a recording medium that stores commands executable by a computer. The commands may be stored in the form of program codes, and when executed by a processor, a program module may be generated to perform the operations of the disclosed embodiments. The recording medium may be implemented as a computer-readable recording medium.

The computer-readable recording medium includes all types of recording media that store commands that may be decoded by a computer. For example, there may be ROM (read only memory), RAM (random access memory), magnetic tape, magnetic disk, flash memory, optical data storage devices, and the like.

The disclosed embodiments have been described with reference to the attached drawings as described above. Those skilled in the art will understand that the present invention may be implemented in different forms from the disclosed embodiments without changing the technical idea or essential features of the present invention. The disclosed embodiments are exemplary and should not be construed as limiting.

### REFERENCE SIGNS LIST

1: Speaker verification system
10: User terminal
20: Speaker verification device
30: Network
210: Communication interface
220: Processor
230: Memory
240: Student network
250: Teacher network

1. A speaker verification device comprising:
a memory configured to store a neural network model including a student network and a teacher network; and
at least one processor configured to train the neural network model, wherein
the at least one processor is configured to:
determine a first loss function based on a difference between outputs of the student network and the teacher network for unlabeled utterances;
determine a second loss function based on a difference between an output of the student network for labeled utterances and a one-hot encoding result for the labeled utterances;
update parameters of the student network based on the first and second loss functions; and
update parameters of the teacher network based on an exponential moving average of the updated parameters of the student network.

2. The speaker verification device of claim 1, wherein
each of the student network and the teacher network includes:
an encoder configured to convert segments of utterances into speaker embeddings; and
a projection head configured to map the speaker embeddings into a high-dimensional space, and
the projection head includes:
a multilayer perceptron; and
a projection layer configured to receive a representation output from the multilayer perceptron and map the representation into a high-dimensional space.

3. The speaker verification device of claim 2, wherein
the at least one processor is configured to:
determine an auxiliary contrastive loss function based on a cosine similarity between the representation output from the multilayer perceptron of the student network and the speaker embedding output from the encoder of the teacher network; and
update the parameters of the student network based on the auxiliary contrastive loss function.

4. The speaker verification device of claim 3, wherein
the at least one processor is configured to determine a positive component of the auxiliary contrastive loss function such that the cosine similarity between the representation of the student network and the speaker embedding of the teacher network, both derived from the same utterance, approaches 1.

5. The speaker verification device of claim 3, wherein
the at least one processor is configured to determine a negative component of the auxiliary contrastive loss function such that the cosine similarity between the representation of the student network output based on labeled utterances and the speaker embedding of the teacher network output based on unlabeled utterances becomes less than 0.

6. The speaker verification device of claim 1, wherein
the at least one processor is configured to sequentially perform pre-training without a margin penalty and fine-tuning training with a margin penalty when updating the parameters of the student network and the teacher network.

7. The speaker verification device of claim 6, wherein
the at least one processor is configured to control a temperature of a softmax function, which controls sharpness of network outputs to be higher in the student network than in the teacher network during the pre-training.

8. The speaker verification device of claim 7, wherein
the at least one processor is configured to control the temperature to be the same for both the student network and the teacher network during the fine-tuning training.

9. A method for controlling a speaker verification device comprising a memory configured to store a neural network model including a student network and a teacher network, and at least one processor configured to train the neural network model, the method comprising:
determining a first loss function based on a difference between outputs of the student network and the teacher network for unlabeled utterances;
determining a second loss function based on a difference between an output of the student network for labeled utterances and a one-hot encoding result for the labeled utterances;
updating parameters of the student network based on the first and second loss functions; and
updating parameters of the teacher network based on an exponential moving average of the updated parameters of the student network.

10. The method for controlling the speaker verification device of claim 9, wherein
each of the student network and the teacher network includes:
an encoder configured to convert segments of utterances into speaker embeddings; and
a projection head configured to map the speaker embeddings into a high-dimensional space,
the projection head includes:
a multilayer perceptron; and
a projection layer configured to receive a representation output from the multilayer perceptron and map the representation into a high-dimensional space, the method further comprising:
determining an auxiliary contrastive loss function based on a cosine similarity between the representation output from the multilayer perceptron of the student network and the speaker embedding output from the encoder of the teacher network; and
updating the parameters of the student network based on the auxiliary contrastive loss function.

11. The method for controlling the speaker verification device of claim 10, wherein
the determining of the auxiliary contrastive loss function includes determining a positive component of the auxiliary contrastive loss function such that the cosine similarity between the representation of the student network and the speaker embedding of the teacher network, both derived from the same utterance, approaches 1.

12. The method for controlling the speaker verification device of claim 10, wherein
the determining of the auxiliary contrastive loss function includes determining a negative component of the auxiliary contrastive loss function such that the cosine similarity between the representation of the student network output based on labeled utterances and the speaker embedding of the teacher network output based on unlabeled utterances becomes less than 0.

13. The method for controlling the speaker verification device of claim 9, further comprising:
sequentially performing pre-training without a margin penalty and fine-tuning training with a margin penalty when updating the parameters of the student network and the teacher network.

14. The method for controlling the speaker verification device of claim 13, wherein
the sequentially performing of the pre-training and the fine-tuning training includes controlling a temperature of a softmax function, which controls sharpness of network outputs to be higher in the student network than in the teacher network during the pre-training.

15. The method for controlling the speaker verification device of claim 13, wherein
the sequentially performing of the pre-training and the fine-tuning training includes controlling the temperature to be the same for both the student network and the teacher network during the fine-tuning training.

16. A speaker verification system comprising:
a user terminal; and
a speaker verification device which receives utterances and a speaker verification request from the user terminal, inputs the received utterances into a neural network model, performs speaker verification based on an output of the neural network model, and sends a speaker verification result to the user terminal,
the speaker verification device including:
a memory configured to store the neural network model; and
at least one processor configured to train the neural network model, wherein
the at least one processor is configured to:
determine a first loss function based on a difference between outputs of the student network and the teacher network of the neural network model for unlabeled utterances;
determine a second loss function based on a difference between an output of the student network for labeled utterances and a one-hot encoding result for the labeled utterances;
update parameters of the student network based on the first and second loss functions; and
update parameters of the teacher network based on an exponential moving average of the updated parameters of the student network.
